(19) United States
(12) Patent Application Publication
(10) Pub. No.: US 2026/0103122 A1
(43) Pub. Date: Apr. 16, 2026

(54) Vehicle Seat Recliner Assembly Having Cross Rod And Hub

(71) Applicant: Fisher & Company, Incorporated, St. Clair Shores, MI (US)

(72) Inventors: Ralph L. SCHMITZ, Clinton Township, MI (US); Sapan Mahendra POPTANI, Northville, MI (US); Christopher J. RYAN, Fraser, MI (US)

(73) Assignee: Fisher & Company, Incorporated, St. Clair Shores, MI (US)

(21) Appl. No.: 19/339,839

(22) Filed: Sep. 25, 2025

Related U.S. Application Data
(60) Provisional application No. 63/708,114, filed on Oct. 16, 2024.
(60) Provisional application No. 63/796,674, filed on Apr. 29, 2025.

(51) Int. Cl. B60N 2/20; B60N 2/235; B60N 2/68

(52) U.S. Cl. CPC B60N 2/20; B60N 2/236; B60N 2/68; B60N 2205/50

(57) ABSTRACT

A vehicle seat recliner assembly includes a first recliner heart assembly including a first hub mounted to a first bracket, a second recliner heart assembly including a second hub mounted to a second bracket, and a cross member extending between the first recliner heart assembly and the second recliner heart assembly. The cross member includes a first end section engaged with the first hub and a second end section engaged with the second hub. The second end section includes a groove that is captured by the second hub to prevent inadvertent removal of the cross member from the vehicle seat recliner assembly.

### CROSS-REFERENCE TO RELATED APPLICATIONS

This application claims the benefit of U.S. Provisional Application No. 63/796,674, filed on Apr. 29, 2025 and U.S. Provisional Application No. 63/708,114, filed on Oct. 16, 2024. The entire disclosures of the above applications are incorporated herein by reference.

### FIELD

The present disclosure relates to a vehicle seat recliner assembly having a cross rod and a hub.

### BACKGROUND

This section provides background information related to the present disclosure and is not necessarily prior art.

Vehicle seats typically include a seat recliner assembly that allows selective adjustment of an angular position of a seatback relative to a seat bottom. Such seat recliner assemblies may include a pair of recliner mechanisms disposed at opposite ends of a base of the seatback to maintain torsional stiffness of the seatback when the seatback is in a locked position. Because each recliner mechanism maintains the seatback in the locked position, each recliner mechanism must be moved from a locked state into an unlocked state to permit movement of the seatback relative to the seat bottom. A single release handle (or lever) is often employed to release both recliner mechanisms to allow the seatback to rotate relative to the seat bottom. A cross member may extend between the two recliner mechanisms and may transmit torque from the release handle between the recliner mechanisms. The present disclosure provides an improved cross member that reduces manufacturing costs, improves durability, and performs well.

### SUMMARY

This section provides a general summary of the disclosure and is not a comprehensive disclosure of its full scope or all of its features.

In one example form, the present disclosure provides a vehicle seat recliner assembly that may include a first recliner heart assembly including a first hub, a second recliner heart assembly including a second hub, and a cross member extending between the first recliner heart assembly and the second recliner heart assembly. The cross member including a first end section engaged with the first hub and a second end section engaged with the second hub. The second end section includes a groove that is captured by the second hub to prevent inadvertent removal of the cross member from the vehicle seat recliner assembly.

In some configurations, the cross member includes a polygonal profile, and the In other features, the second hub includes a first end portion, a second end portion, and a polygonal aperture extending from the first end portion to the second end portion, the first end portion including an annular flange.

In some configurations, the second end portion of the second hub includes a plurality of resiliently flexible fingers that selectively engage the groove in the cross member.

In some configurations, each of the plurality of resiliently flexible fingers includes an inner surface supporting a radially inwardly projecting barb.

In some configurations, the radially inwardly projecting barb is configured to engage the groove in the cross member.

In some configurations, the radially inwardly projecting barb includes a bulbous profile.

In some configurations, the groove is shaped to retain the radially inwardly projecting barb and restrict removal of the cross member from the second hub.

In some configurations, each of the plurality of resiliently flexible fingers is cantilevered from the annular flange.

In some configurations, the second hub includes an intermediate portion extending between the annular flange and each of the plurality of resiliently flexible fingers the intermediate portion including an outer surface having an annular recess.

In some configurations, the second recliner heart assembly includes a hub retainer having an annular ring and a plurality of hub retaining members, the second hub extending through the hub retainer.

In some configurations, the plurality of hub retaining members include a plurality of cantilevered flexible fingers that form an inner diameter of the hub retainer.

In some configurations, the second recliner heart assembly includes a ratchet plate having an inner aperture, and wherein the hub retainer is disposed within the inner aperture of the ratchet plate.

In some configurations, the plurality of cantilevered flexible fingers extend radially inward from the annular ring into the annular recess formed in the intermediate portion and engage the second hub.

In some configurations, each of the plurality of cantilevered flexible fingers includes a first section and a second section, wherein the first section extends radially into the inner aperture of the ratchet plate, and wherein the second section that extends at an angle relative to the first section.

In some configurations, each of the plurality of cantilevered flexible fingers is spring biased.

In some configurations, the second section of each of the plurality of hub retaining members extends into the annular recess.

In some configurations, each of the plurality of cantilevered flexible fingers is resiliently flexible.

In another example, the present disclosure provides a vehicle seat assembly that may include a seat bottom having a seat bottom frame, a seatback having a seatback frame, a first recliner assembly including a first bracket coupled to the seat bottom frame, a second bracket coupled to the seatback frame, and a first recliner heart assembly connected to the first bracket and the second bracket, the first recliner heart assembly including a first hub. The vehicle seat also includes a second recliner assembly including a third bracket coupled to the seat bottom frame, a fourth bracket coupled to the seatback frame, and a second recliner heart assembly connected to the third bracket and the fourth bracket, the second recliner heart assembly including a second hub. A cross member extends between the first recliner heart assembly and the second recliner heart assembly. The cross member includes a first end section engaged with the first hub and a second end section engaged with the second hub. The second end section includes a groove that is captured by the second hub to prevent inadvertent removal of the cross member from the first and second recliner assemblies.

In some configurations, the cross member includes a polygonal profile, and the groove is generally cylindrical.

In some configurations, the second hub includes a first end portion, a second end portion, and a polygonal aperture extending from the first end portion to the second end portion, the first end portion including an annular flange.

In some configurations, the second end portion of the second hub includes a plurality of resiliently flexible fingers that selectively engage the groove in the cross member.

In some configurations, each of the plurality of resiliently flexible fingers includes an inner surface supporting a radially inwardly projecting barb.

In some configurations, the radially inwardly projecting barb is configured to engage the groove in the cross member.

In some configurations, the radially inwardly projecting barb includes a bulbous profile.

In some configurations, the groove is shaped to retain the radially inwardly projecting barb and restrict removal of the cross member from the second hub.

In some configurations, each of the plurality of resiliently flexible fingers is cantilevered from the annular flange.

In some configurations, the second hub includes an intermediate portion extending between the annular flange and each of the plurality of resiliently flexible fingers the intermediate portion including an outer surface having an annular recess.

In some configurations, the second recliner heart assembly includes a hub retainer having an annular ring and a plurality of hub retaining members, the second hub extending through the hub retainer.

In some configurations, the plurality of hub retaining members include a plurality of cantilevered flexible fingers that form an inner diameter of the hub retainer.

In some configurations, the second recliner heart assembly includes a ratchet plate having an inner aperture, and wherein the hub retainer is disposed within the inner aperture of the ratchet plate.

In some configurations, the plurality of cantilevered flexible fingers extend radially inward from the annular ring into the annular recess formed in the intermediate portion and engage the second hub.

In some configurations, each of the plurality of cantilevered flexible fingers includes a first section and a second section, wherein the first section extends radially into the inner aperture of the ratchet plate, and wherein the second section that extends at an angle relative to the first section.

In some configurations, each of the plurality of cantilevered flexible fingers is spring biased.

In some configurations, the second section of each of the plurality of hub retaining members extends into the annular recess.

In some configurations, each of the plurality of cantilevered flexible fingers is resiliently flexible.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a partial perspective view of a vehicle having a seat incorporating a recliner assembly according to the principles of the present disclosure;

FIG. 2 is a side view of the recliner assembly of FIG. 1 with the seat in a reclined position, in accordance with the present disclosure;

FIG. 3 is a perspective view of the recliner assembly of FIG. 1 illustrating a first recliner mechanism connected to a second recliner mechanism through a cross member, in accordance with the present disclosure;

FIG. 4 is an exploded view of the first recliner mechanism and a portion of the cross member of FIG. 3, in accordance with the present disclosure;

FIG. 5 is an exploded view of the second recliner mechanism and another portion of the cross member of FIG. 3, in accordance with the present disclosure;

FIG. 6 is a cross-sectional view of the recliner assembly of FIG. 3 showing the cross member in a disengaged state with the first recliner mechanism;

FIG. 7 is a cross-sectional view of the recliner assembly of FIG. 3 showing the cross member in an assembled and engaged state with the first recliner mechanism;

FIG. 8 is a cross-sectional view of the second recliner mechanism of the recliner assembly of FIG. 1 including a hub engaged to the cross member, in accordance with the present disclosure;

FIG. 9 is a cross-sectional view of the second recliner mechanism of the recliner assembly of FIG. 3 before installation of the cross member, in accordance with the present disclosure;

FIG. 10 is a partial perspective view of the cross member of the recliner assembly of FIG. 3, in accordance with the present disclosure; and

FIG. 11 is a cross-sectional view partial perspective view of the first recliner mechanism of the recliner assembly of FIG. 3 depicting the cross member being engaged by the hub, in accordance with the present disclosure.

### DETAILED DESCRIPTION

Example embodiments will now be described more fully with reference to the accompanying drawings.

The present disclosure provides an improved cross rod and hubs that allows the cross rod to be retained relative to the hub in a manner that minimizes weight, number of parts, cost, and packaging space while allowing for easy installation and reducing noise and vibration.

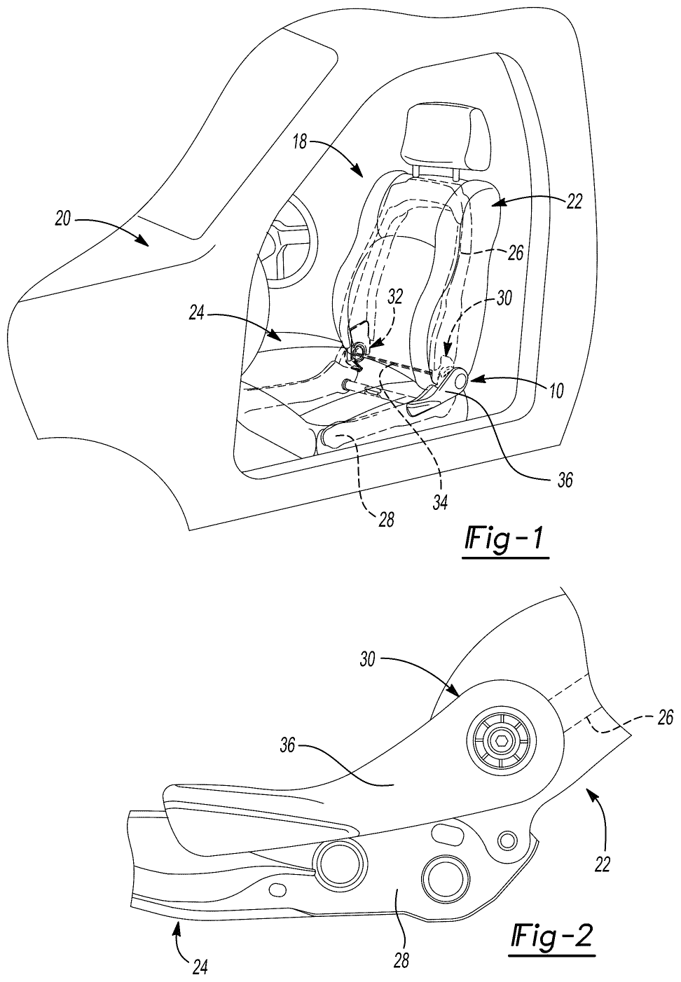

With reference to FIG. 1, a recliner assembly 10 is provided that may be incorporated into a vehicle seat assembly 18 arranged in a vehicle 20. Vehicle seat assembly 18 includes a seatback 22 and a seat bottom 24. The seatback 22 and seat bottom 24 may include a seatback frame 26 and a seat bottom frame 28, respectively. The recliner assembly 10 may include a first recliner mechanism 30, a second recliner mechanism 32, a cross member 34, and a hand lever 36 (or release lever).

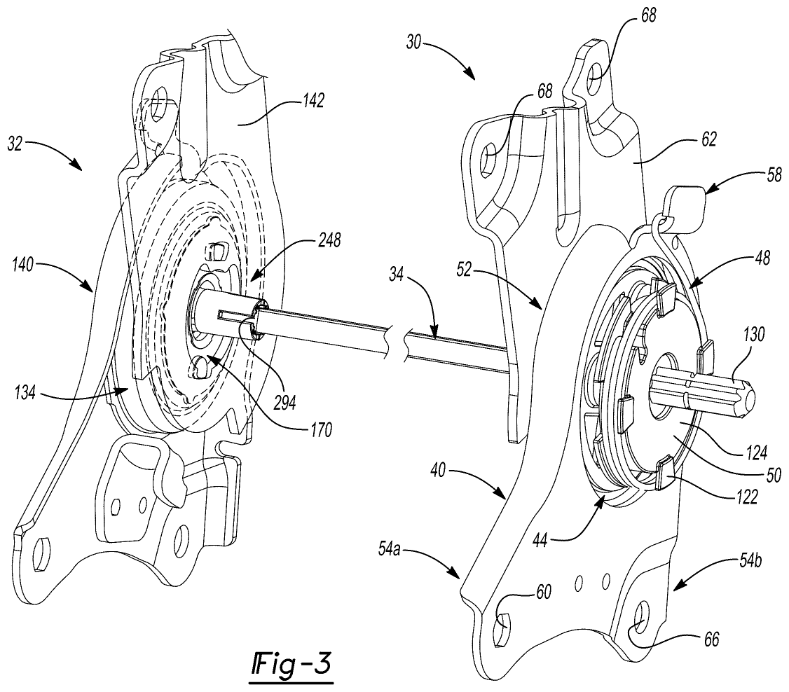

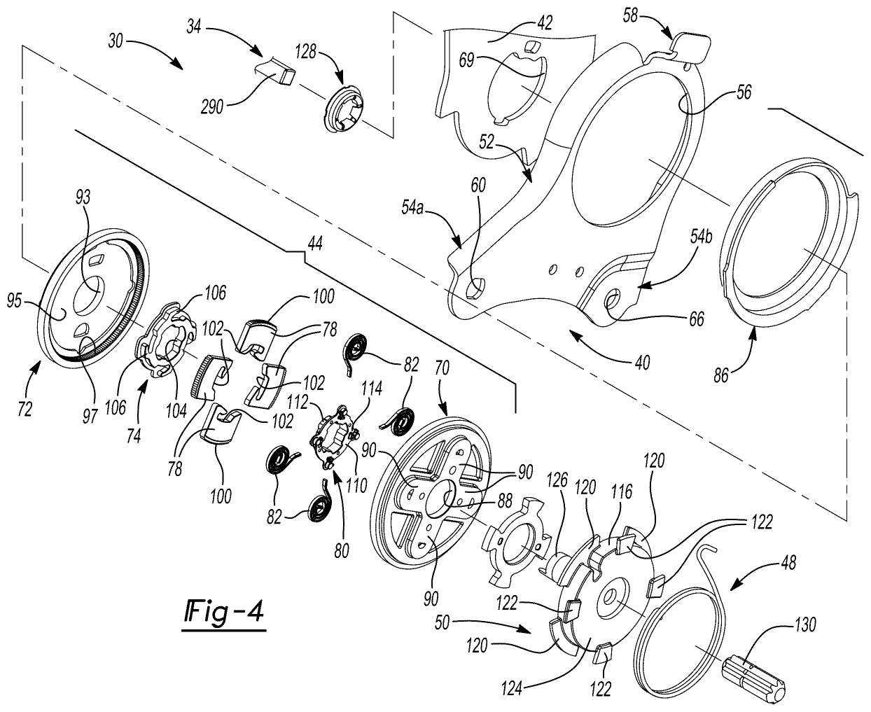

The first recliner mechanism 30 and the second recliner mechanism 32 may be operable in a locked state preventing relative rotation between the seatback 22 and the seat bottom 24 and an unlocked state permitting relative rotation between the seatback 22 and seat bottom 24 among an upright position (FIG. 1), a rearward reclined position (FIG. 2) and a forward dump position (not shown). As shown in FIGS. 3 and 4, the first recliner mechanism 30 may include a first bracket 40, a second bracket 42, a first recliner heart assembly (or locking mechanism) 44, an outer coil spring 48, and a first hub 50. First bracket 40 connects with seat bottom 23 and second bracket 42 connects with seatback 22. As will be detailed more fully herein, second recliner mechanism 32 includes similar structure.

As shown in FIG. 4 and with continued reference to FIG. 3, the first bracket 40 may include a generally round main body 52, a first mounting lobe 54a, and a second mounting lobe 54b that extend outward from the main body 52. The main body 52 may include a central aperture 56 and a tab 58. The first mounting lobe 54a may include a first aperture 60 and second mounting lobe 54b includes a second aperture 66 through which fasteners (not shown) may extend to securely attach the first bracket 40 to the seat bottom frame 28 of the vehicle seat assembly 18.

As shown in FIGS. 3 and 4, the second bracket 42 may be generally rectangular and may include a plurality of apertures 68, and a central aperture 69 through which the cross member 34 extends. Fasteners (not shown) may extend through the plurality of apertures 62 to securely attach the second bracket 42 to the seatback frame 26 of the seat assembly 18.

As shown in FIG. 4, first recliner heart assembly 44 may be mounted to the first bracket 40 and second bracket 42 and may include a guide plate 70, a ratchet plate 72, a cam 74, a plurality of pawls 78, a connector disk 80, a plurality of coil springs 82, and an encapsulation ring 86. The first recliner heart assembly 44 may be operable to lock the first recliner mechanism 30 thus preventing relative rotation between the seatback 22 and the seat bottom 24, and to also unlock the first recliner mechanism 30, thus permitting relative rotation between the seatback 22 and seat bottom 24.

The guide plate 70 may be mounted to the first bracket 40. The guide plate 70 may be a generally round, flat disk with a central aperture 88 (FIG. 4) and a plurality of bosses 90. Each of the pawls 78 is slidably received between corresponding adjacent bosses 90.

The ratchet plate 72 may be a generally round, flat disk and may include a central aperture 93 and a cylindrical recess 95. The cylindrical recess 95 may include a plurality of teeth 97 disposed on an inner diameter defining the cylindrical recess 95. The second bracket 42 may be welded and/or otherwise suitably fixed to the seatback 22. Likewise, the second bracket 42 may be welded to the ratchet plate 72 to establish an interface with the seatback 22. The ratchet plate 72 may be mounted to the guide plate 70 with the cylindrical recess 95 disposed substantially concentric with outer radii of the bosses 90. The encapsulation ring 86 has a generally U-shaped cross-section and may be disposed generally around the peripheries of the ratchet plate 72 and the guide plate 70. In this configuration, encapsulation ring 86 rotatably couples the ratchet plate 72 to the guide plate 70.

The plurality of pawls 78 may be radially disposed around the central aperture 88 on the guide plate 70. Plurality of pawls 78 may also be slidably mounted to the guide plate 70 generally between the bosses 90. An edge of each pawl 78 may include teeth 100 adapted for meshing engagement with the teeth 97 of the ratchet plate 72. Each pawl 78 may also include a latch 102 at an end opposite the teeth 100.

The cam 74 may be a generally round disk having an aperture 104 and a plurality of radial latch protrusions 106 arranged around the aperture 104. The cam 74 is rotatable relative to the pawls 78 and the ratchet plate 72 such that the latch protrusions 106 can selectively engage the latches 102 of the pawls 78 to move the pawls 78 out of engagement with the teeth 97 of the ratchet plate 72 (i.e., into the unlocked state).

The connector disk 80 is engaged with the cam 74 and the first hub 50. As shown in FIG. 4, the connector disk 80 may include a disk portion 110 and an extrusion 112 extending perpendicularly from the disk portion 110. Extrusion 112 nests within aperture 104 of cam 74. The disk portion 110 may have a plurality of flanges 114 extending therefrom. Each flange 114 is engaged with a corresponding one of the coil springs 82. Because each flange 114 is engaged to the corresponding coil spring 82, the connector disk 80 rotationally biases the cam 74 in a manner that causes the latch protrusions 106 to force the pawls 78 radially outwardly into the locked state, whereby the teeth 100 of the pawls 78 engage the teeth 97 of the ratchet plate 72.

The extrusion 112 of the connector disk 80 is engaged with the first hub 50 and the cam 74 such that rotation of the first hub 50 (which is caused by rotation of the hand lever 16) causes rotation of the cam 74 to move the pawls 78 radially into and out of engagement with the teeth 97 of the ratchet plate 72.

The outer coil spring 46 may exert a torsional force that biases the first recliner mechanism 30 toward a locked state. The outer coil spring 48 may wrap around the first hub 50 and engage the first bracket 40 and the hand lever 36. First hub 50 includes a coil spring support surface 116 that supports outer coil spring 48 between a plurality of inner flange elements 120 and a plurality of outer flange elements 122. The outer coil spring 46 may rotationally bias the seatback 22 toward the upright position relative to the seat bottom 24.

The first hub 50 may extend through the length of the first recliner heart assembly 44 and may include a first end 124 and a second end 126. The first end 124 may engage guide plate 70 such that first hub 50 and guide plate 70 are rotationally fixed to each other. A first hub retainer 128 secures second end 126 to ratchet plate 72. A handle connector 130 is connected to first hub 50. Release hand lever 36 may engage the handle connector 130 such that release hand lever 36, hub 50, and cross member 34 are rotationally fixed relative to each other. Handle connector 130 provides an interface between first hub 50 and release hand lever 36 that avoids the need to include an additional fastener that would otherwise engage with the cross member 34.

Second recliner mechanism 32 includes structure similar to first recliner mechanism 30. Further, second recliner mechanism 32 includes a second recliner heart assembly 134 that may be mounted to a third bracket 140 and a fourth bracket 142. In a manner similar to that discussed above with respect to first and second brackets 40, 42, third bracket 140 is connected to seat bottom 22 and fourth bracket 142 is connected to seat back 24. The structure and function of the third and fourth brackets 140, 142 may be similar or identical to that of the first and second brackets 40, 42, respectively.

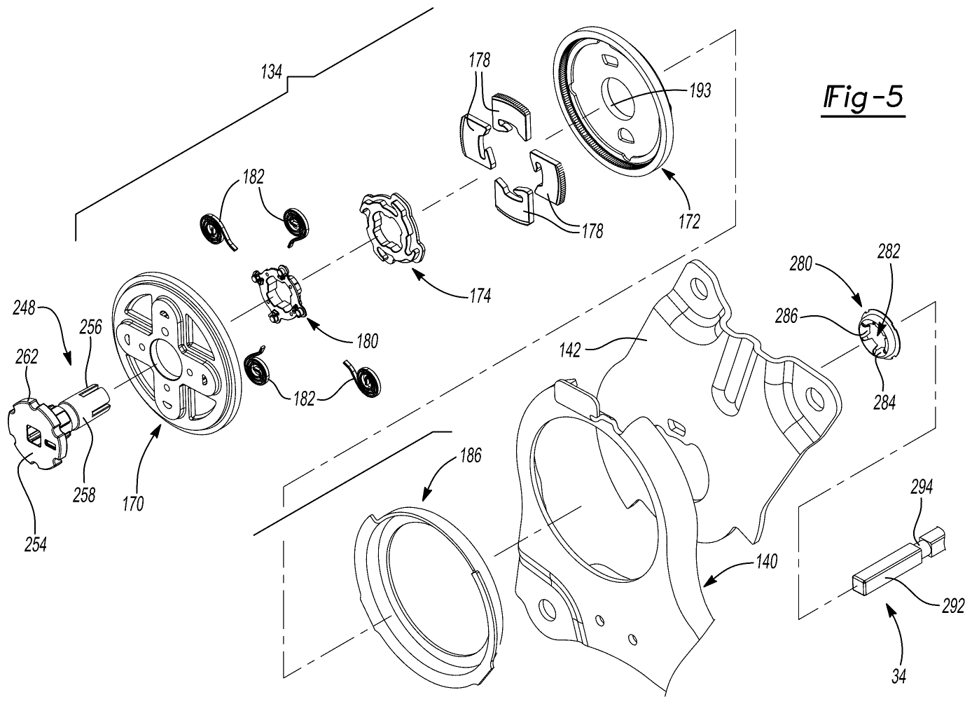

Second recliner heart assembly 134 is arranged on an opposite side of vehicle seat assembly 18 of first bracket 40 (i.e., first recliner heart assembly 44 and second recliner heart assembly 134 are disposed on opposite lateral sides of the seat assembly 18). As shown in FIG. 5, second recliner heart assembly 134 includes a guide plate 170, a ratchet plate 172, a cam 174, a plurality of pawls 178, a connector disk 180, a plurality of coil springs 182, and an encapsulation ring 186. The structure and function of guide plate 170, ratchet plate 172, cam 174, pawls 178, connector disk 180, coil springs 182, and encapsulation ring 186 may be similar or identical to that of guide plate 70, ratchet plate 72, cam 74, pawls 78, connector disk 80, coil springs 82, and encapsulation ring 86, respectively.

Like the first recliner heart assembly 44, the second recliner heart assembly 134 may be operable to lock the second recliner mechanism 32, thus further preventing relative rotation between the seatback 22 and the seat bottom 24, and to also unlock the second recliner mechanism 32, thus permitting relative rotation between the seatback 22 and seat bottom 24.

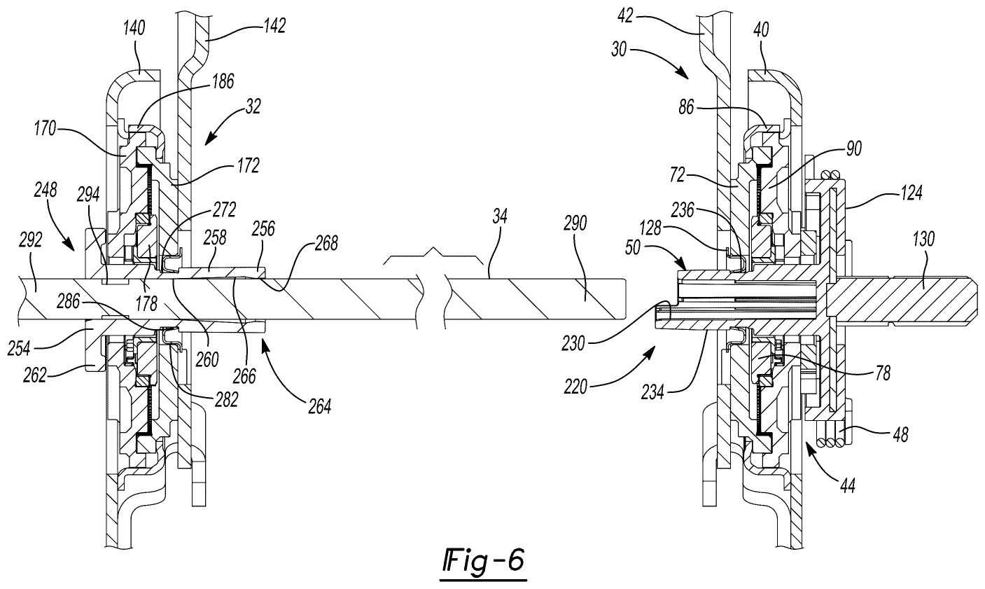

As shown in FIG. 6, the first hub 50 may include a cross member support 220 having a rectangular-shaped aperture 230 that receives the cross member 34 and an outer surface 234 having an annular recess 236 that is captured by first hub retainer 128. The cross-sectional shape of the aperture 230 generally corresponds to the cross-sectional shape of a portion of the cross member 34 such that the cross member 34 and the first hub 50 are rotationally fixed relative to each other. To enable the seatback 22 to pivot relative to the seat bottom 24, a user may pivot the hand lever 36 in a clockwise direction thus rotating cross member 34 and first hub 50 in first recliner mechanism 30. Accordingly, clockwise rotation of the cross member 34 causes the cam 74 to similarly rotate in a clockwise direction relative to the plurality of pawls 78, overcoming a counterclockwise rotational bias of the outer coil spring 46.

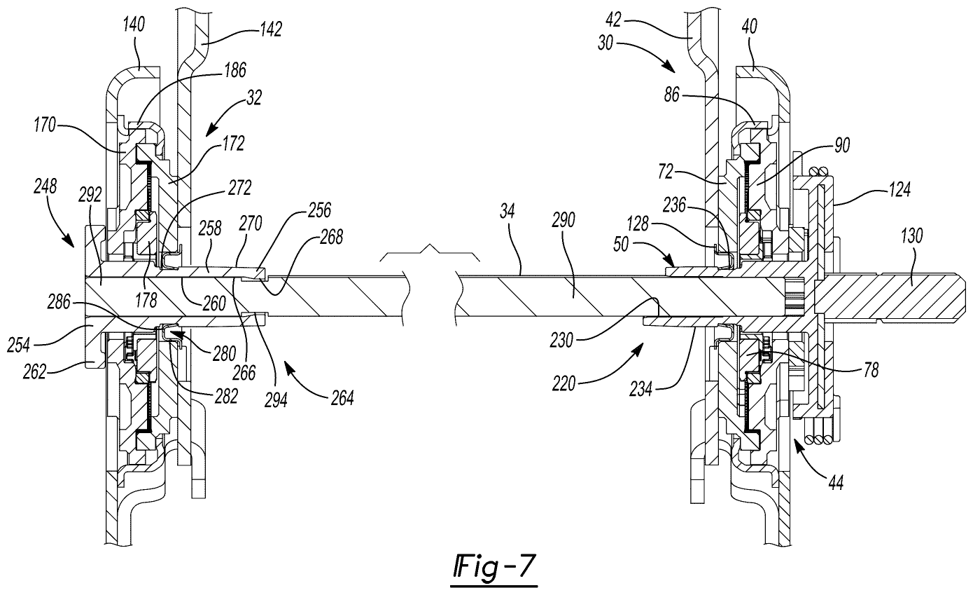

Second recliner mechanism 32 also includes a second hub 248 that extends through third bracket 140, fourth bracket 142, and second recliner heart assembly 134. When assembling seat 18, cross member 34 is passed through second hub 248, through vehicle seat assembly 18, and toward first hub 50 (FIG. 6). Cross member 34 is then seated into rectangular shaped aperture 230 of cross member support 220 (FIG. 7) of first hub 50. As will be detailed herein, when seated in first hub 50, second hub 248 securely connects and is rotationally connected with cross member 34.

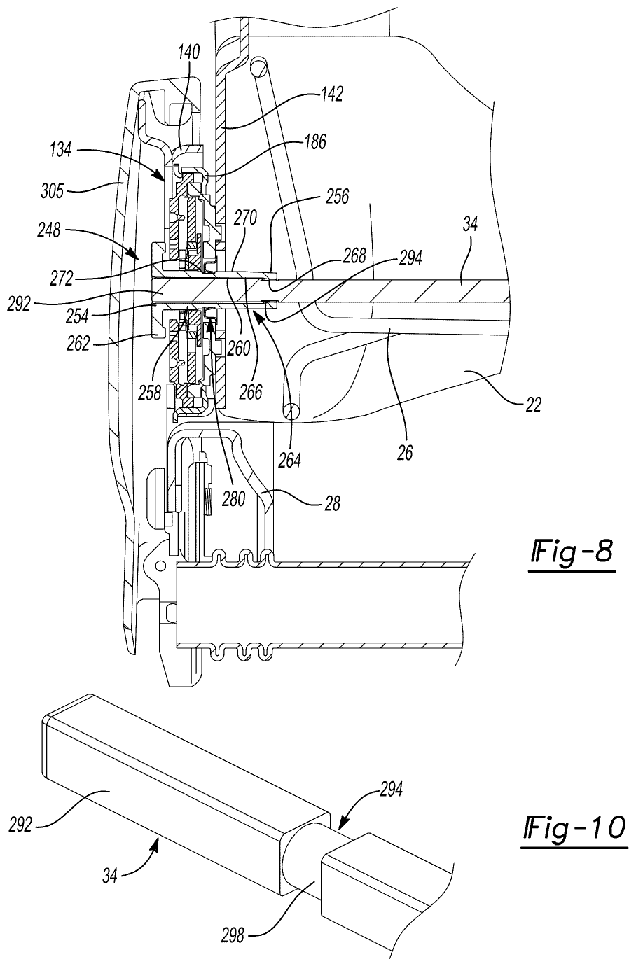

As shown in FIGS. 5-8, second hub 248 includes a first end portion 254, a second end portion 256, an intermediate portion 258. A rectangularly shaped aperture 260 extends between (and through) first end portion 254 and second end portion 256. First end portion 254 includes a flange 262 that engages guide plate 170 such that the second hub 248 may be rotationally fixed relative to the guide plate 170. Second end portion 256 includes a plurality of resiliently flexible fingers 264 that selectively engage with and capture cross member 34 as will be detailed more fully herein. The capture of cross member 34 promotes assembly and operation of recliner assembly 10. While the aperture 260 and cross member 34 are described above as being rectangularly shaped, it will be appreciated that the aperture 260 and cross member 34 could have any other polygonal shapes that allow the cross member 34 to be received in the aperture 260 in a manner that rotationally fixes the cross member 34 relative to hub 248 (i.e., so that torque can be transmitted from the cross member 34 to the hub 248.

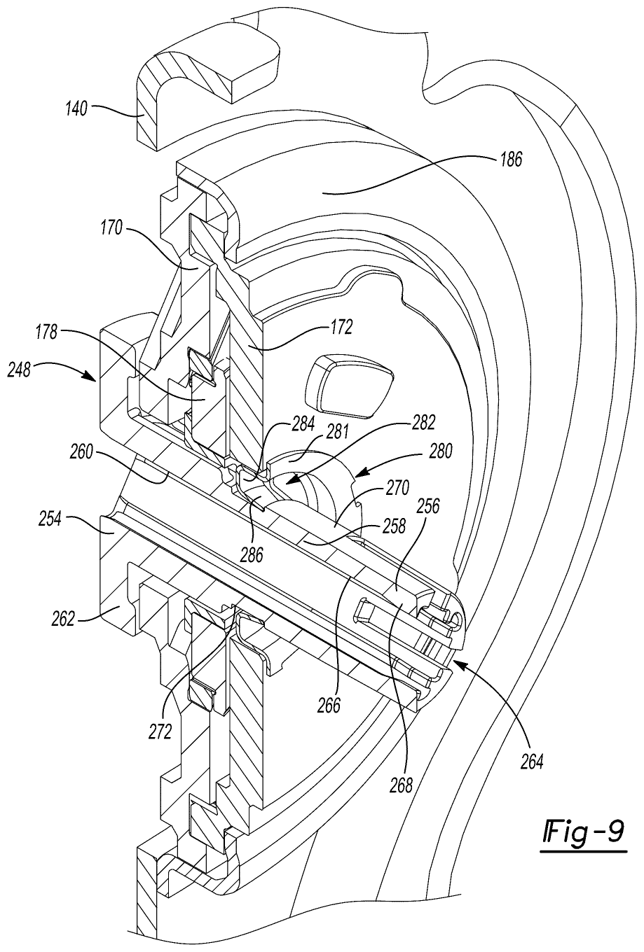

As shown in FIG. 9, the plurality of fingers 264 may be cantilevered resilient beam elements that each include an inner surface 266 from which extends a barb or bulbous member 268 that snaps into engagement with cross member 34. Barb 268 extends radially inwardly from select ones of the plurality of fingers 264. Second hub 248 also includes an outer surface 270 having an annular recess 272. Annular recess 272 is formed in intermediate portion 258.

Second hub 248 is supported in second recliner mechanism 32 by guide plate 170, ratchet plate 172, and encapsulating ring 186. Guide plate 170 supports rotation of seatback 22 relative to seat bottom 24 in a manner similar to that discussed herein with respect to first recliner mechanism 30. Connector disk 180 supports guide plate 170. A second hub retainer 280 is arranged in inner aperture 193 of ratchet plate 172. Second hub retainer 280 includes an annular ring 281 that supports a plurality of hub retaining members 282 that engage into annular recess 272 to affix second hub 248 to ratchet plate 172 of second recliner mechanism 32. Hub retaining members 282 take the form of resiliently flexible cantilevered fingers (not separately labeled) that form an inner diameter (also not separately labeled) of second hub retainer 280. Each hub retaining member 282 includes a first section 284 that extends radially into inner aperture 193 of ratchet plate 172 and a second section 286 that extends at an angle relative to the first section 284. Second section 286 is spring biased (i.e., resiliently flexible) to snap into annular recess 272 thereby securing second hub 248 to ratchet plate 172. It should be understood that the structure and function of first hub retainer 128 may be similar or identical to that of second hub retainer 280.

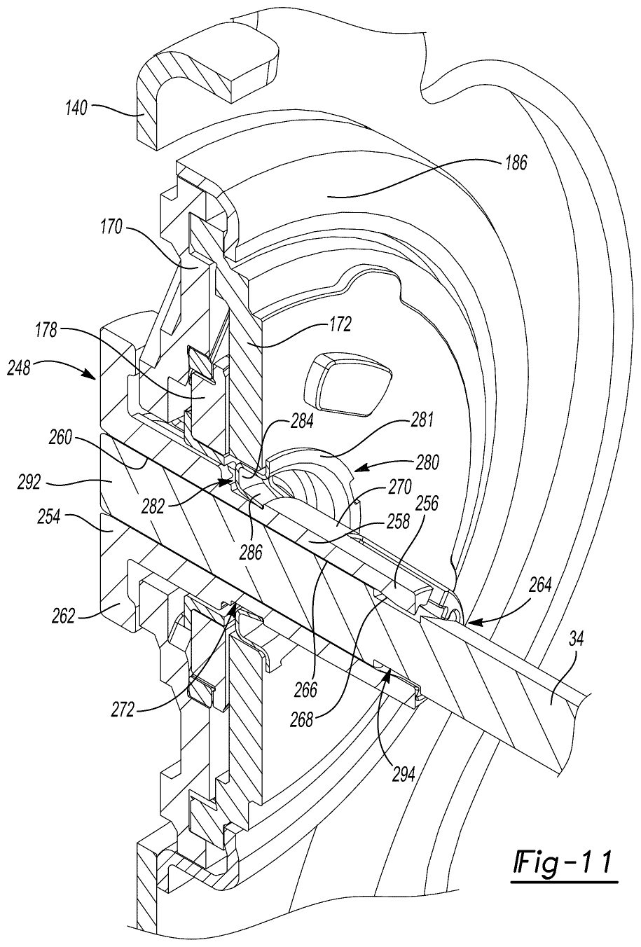

Referring to FIGS. 10 and 11 and with continued reference to FIGS. 6 and 7 cross member 34 includes a first end section 290 and a second end section 292 that is opposite of first end section 290. Cross member 34 includes a groove 294 adjacent to second end section 292. The groove 294 may be formed with a specific depth and edge sharpness that contributes to the ability of the plurality of fingers 164 to maintain engagement with the cross member 34. The particular shape of groove 294 and barb 268 ensures that cross member 34 will not release from first hub 50 or second hub 248. Further, the particular interface provided by groove 294 and barb 268 substantially eliminates rattling, buzzing, and the like that might otherwise be produced by the vibration of first recliner mechanism 30 and/or second recliner mechanism 32 if cross member 34 were to become loose.

Second end section 292 of cross member 34 includes a generally rectangular profile with groove 294 including a generally annular or cylindrical surface 298 having a generally circular cross-section. Generally cylindrical surface 298 defines an axial length of groove 294.

With this construction, cross member 34 may be inserted through second hub 248 in second recliner mechanism 32 and shifted/slid/inserted through vehicle seat assembly 18 into first hub 50 of first recliner mechanism 30. As second end section 292 nears second end portion 256 of second hub 248, barbs 268 will snap into groove 294 locking cross member 34 to first recliner mechanism 30 and second recliner mechanism 32.

At this point, it should be appreciated that second hub 248 in second recliner mechanism 32 allow the cross member 34 to be inserted through the rectangularly shaped aperture 260 (i.e., during assembly of the recliner assembly), and engagement between the plurality of fingers 264 and the groove 294 retain the cross member 34 relative to the second hub 248 to prevent inadvertent removal of the cross member 34 and/or mitigate any undesirable sounds that could occur stemming from a loose connection. Further, the reclining mechanism of described in accordance with the present disclosure enables the operating handle to be connected to the recliner heart without the need for fasteners thereby simplifying the manufacturing process for the cross member.

The engagement between the plurality of fingers 264 and the groove 294 restrict or prevent the cross member 34 rod from inadvertently sliding relative to the second hub 248. The plurality of fingers 264 also apply forces to the cross member 34 that reduce or prevent vibration thereby reducing noise (i.e., reduce or prevent buzz, squeak, and rattle (BSR)). The configuration of the second hub 248 and cross member 34 also provides a desired amount of clearance between a plastic side cover 305 (FIG. 7) and the second hub 248/cross member 34. The clearance created by second hub 248 facilitates the locking of first recliner heart assembly 44 and second recliner heart assembly 134 when release hand lever 36 is released.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When the terms “about” or “substantially” are used in this specification in connection with a numerical value, it is intended that the associated numerical value includes a manufacturing or operational tolerance around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance around the stated numerical values or shapes.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle seat recliner assembly comprising:
a first recliner heart assembly including a first hub;
a second recliner heart assembly including a second hub; and
a cross member extending between the first recliner heart assembly and the second recliner heart assembly, the cross member including a first end section engaged with the first hub and a second end section engaged with the second hub, the second end section including a groove that is captured by the second hub to prevent inadvertent removal of the cross member from the vehicle seat recliner assembly.

2. The vehicle seat recliner assembly of claim 1, wherein the cross member includes a polygonal profile, and the groove is generally cylindrical.

3. The vehicle seat recliner assembly of claim 2, wherein the second hub includes a first end portion, a second end portion, and a polygonal aperture extending from the first end portion to the second end portion, the first end portion including an annular flange.

4. The vehicle seat recliner assembly of claim 3, wherein the second end portion of the second hub includes a plurality of resiliently flexible fingers that selectively engage the groove in the cross member.

5. The vehicle seat recliner assembly of claim 4, wherein each of the plurality of resiliently flexible fingers includes an inner surface supporting a radially inwardly projecting barb.

6. The vehicle seat recliner assembly of claim 5, wherein the radially inwardly projecting barb is configured to engage the groove in the cross member.

7. The vehicle seat recliner assembly of claim 6, wherein the groove is shaped to retain the radially inwardly projecting barb and restrict removal of the cross member from the second hub.

8. The vehicle seat recliner assembly of claim 7, wherein each of the plurality of resiliently flexible fingers is cantilevered from the annular flange.

9. The vehicle seat recliner assembly of claim 8, wherein the second hub includes an intermediate portion extending between the annular flange and each of the plurality of resiliently flexible fingers the intermediate portion including an outer surface having an annular recess.

10. The vehicle seat recliner assembly of claim 9, wherein the second recliner heart assembly includes a hub retainer having an annular ring and a plurality of hub retaining members, the second hub extending through the hub retainer.

11. The vehicle seat recliner assembly of claim 10, wherein the plurality of hub retaining members include a plurality of cantilevered flexible fingers that form an inner diameter of the hub retainer.

12. The vehicle seat recliner assembly of claim 11, wherein the second recliner heart assembly includes a ratchet plate having an inner aperture, and wherein the hub retainer is disposed within the inner aperture of the ratchet plate.

13. The vehicle seat recliner assembly of claim 12, wherein the plurality of cantilevered flexible fingers extend radially inward from the annular ring into the annular recess formed in the intermediate portion and engage the second hub.

14. The vehicle seat recliner assembly of claim 13, wherein each of the plurality of cantilevered flexible fingers includes a first section and a second section, wherein the first section extends radially into the inner aperture of the ratchet plate, and wherein the second section that extends at an angle relative to the first section.

15. The vehicle seat recliner assembly of claim 14, wherein each of the plurality of cantilevered flexible fingers is spring biased.

16. The vehicle seat recliner assembly of claim 15, wherein the second section of each of the plurality of hub retaining members extends into the annular recess.

17. A vehicle seat assembly comprising:
a seat bottom having a seat bottom frame;
a seatback having a seatback frame;
a first recliner assembly including a first bracket coupled to the seat bottom frame, a second bracket coupled to the seatback frame, and a first recliner heart assembly connected to the first bracket and the second bracket, wherein the first recliner heart assembly includes a first hub;
a second recliner assembly including a third bracket coupled to the seat bottom frame, a fourth bracket coupled to the seatback frame, and a second recliner heart assembly connected to the third bracket and the fourth bracket, the second recliner heart assembly including a second hub; and
a cross member extending between the first recliner heart assembly and the second recliner heart assembly, the cross member including a first end section engaged with the first hub and a second end section engaged with the second hub, the second end section including a groove that is captured by the second hub to prevent inadvertent removal of the cross member from the first and second recliner assemblies.

18. The vehicle seat assembly of claim 17, wherein the cross member includes a polygonal profile, and the groove is generally cylindrical, and wherein the second hub includes a first end portion, a second end portion, and a polygonal aperture extending from the first end portion to the second end portion, the first end portion including an annular flange.

19. The vehicle seat assembly of claim 18, wherein:
the second end portion of the second hub includes a plurality of resiliently flexible fingers that selectively engage the groove in the cross member,
each of the plurality of resiliently flexible fingers includes an inner surface supporting a radially inwardly projecting barb,
the radially inwardly projecting barb is configured to engage the groove in the cross member,
the groove is shaped to retain the radially inwardly projecting barb and restrict removal of the cross member from the second hub,
each of the plurality of resiliently flexible fingers is cantilevered from the annular flange, and
the second hub includes an intermediate portion extending between the annular flange and each of the plurality of resiliently flexible fingers the intermediate portion including an outer surface having an annular recess.

20. The vehicle seat assembly of claim 19, wherein:
the second recliner heart assembly includes a hub retainer having an annular ring and a plurality of hub retaining members, the second hub extending through the hub retainer,
the plurality of hub retaining members include a plurality of cantilevered flexible fingers that form an inner diameter of the hub retainer,
the second recliner heart assembly includes a ratchet plate having an inner aperture, and wherein the hub retainer is disposed within the inner aperture of the ratchet plate,
the plurality of cantilevered flexible fingers extend radially inward from the annular ring into the annular recess formed in the intermediate portion and engage the second hub,
each of the plurality of cantilevered flexible fingers includes a first section and a second section, wherein the first section extends radially into the inner aperture of the ratchet plate, and wherein the second section that extends at an angle relative to the first section, and
the second section of each of the plurality of hub retaining members extends into the annular recess.
